(19) United States
(12) Patent Application Publication
(10) Pub. No.: US 2007/0065795 A1
(43) Pub. Date: Mar. 22, 2007

(54) Multiple-channel learner-centered whole-brain training system

(76) Inventors: Ranel Einar Erickson, (US); Renaun Eirik Erickson, (US); Dallas Durbin Ricketts, (US)

Correspondence Address: RANEL EINAR ERICKSON, 1028 SAN GABRIEL, HENDERSON, NV, 89002, US

(21) Appl. No.: 11/522,640

(22) Filed: Sep. 18, 2006

Related U.S. Application Data
(60) Provisional application No. 60/719,410, filed on Sep. 21, 2005.

(51) Int. Cl. G09B 5/00

(52) U.S. Cl. 434/307 R

(57) ABSTRACT

This invention provides systems and methods that select and integrate multiple channels of media based on how a learner's historical track record relates to a set of learner-centered rules. When such rules are implemented using computer software, the user experiences multiple channels of media that engage the learner in dynamic rules-based multiple channels based on left-brain and right-brain characteristics.

### CROSS-REFERENCE TO RELATED APPLICATIONS

This non-provisional utility patent application was preceded by the Provisional Application No. 60/719,410 filed on Sep. 21, 2005.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. The Field of the Invention

The invention relates generally to the field of computer-based training and more specifically to systems and methods that integrate multiple channels of media based on how a learner's historical interactions relate to learner-centered rules.

2. The Prior State of the Art

Many computer-based training systems present to the user sequences of multimedia items followed by quizzes and exams whose answers determine the next media items to display. The multimedia items can include video, audio, graphics, images, and text. In the prior art, the way that e-learning systems sequence and integrate content depends primarily on user questionnaires or assessment mechanisms like quizzes and exams. These assessment mechanisms focus mainly on the learner's progress in mastering the material. For some examples, consider the following patents and patent applications:

Dorai discusses systems and methods of content conditioning based on database searches and displaying the information based on a profile for the user. (Method and System for Personalized Content Conditioning, Patent Application No. 20050193335).

Gillani ties cognitive learning theories about multiple intelligences into the selection of presentation material for a particular type of student as determined by user typical assessment strategies. (System and method for dynamic electronic learning based on continuing student assessments and responses, Patent Application No. 20050186550)

LoSasso, et al., introduces a method of interactive training modules that customizes content through ratings from users and with a database that collects and stores data concerning the interactions of individual users with individual scenarios. (Interactive Training System And Method, Patent Application No. 20030008266).

O'Connor, et al. teaches a simulated environment with video and graphics and dynamic feedback that notes users' mistakes and presents remedial instructional material. (Method And Article Of Manufacture For Goal Based Education And Reporting System, U.S. Pat. No. 6,134,539).

Sheehan introduces a method for training users where a programmed computer controls the path of learning and the user controls the pace of learning (Modular Computer-Based Training System, Patent Application No. 20030162159).

Siefert invention stores the school curriculum and maintains a learning profile for the student. Based on the profile, an Intelligent Administrator selects appropriate material and repeats material (in alternative ways) to instill mastery. (Modular Computer-Based Training System, U.S. Pat. No. 6,386,883).

Summers provides a management training simulation system to develop decision-making skills in a simulated situation, where user assessments cause object designs to be injected into the simulation. (Management Training Simulation Method And System, U.S. Pat. No. 6,236,955).

In the cognitive theory literature, there exist studies that different parts of the brain are involved in different aspects of the learning process. Whole brain theory refers to different brains (or different parts of the body's cognitive system). Briefly, the left brain is concerned with logical and analytical skills. The right brain is the center of visual, rhythm, “artistic” abilities. The reflex brain is stimulated by physical activities. The limbic brain links memory with emotion. The new brain is the area of the brain that creates new material. (http://esl.about.com/library/lessons/blbrainoverview.htm)

There also exist studies (referred to as super teaching or super learning) that show how certain combinations of input can significantly impact the learning process by stimulating the whole brain. In B J Dohrmann's paper “Whole Brain Learning—The Super Teaching Story (2005), he claims that the Super Teaching classroom design, continuously elevates whole cortex memory and retention across the spectrum of all learner student bodies. In the article, he argues using various studies that his three-project-screen multimedia-enhanced traditional class rooms achieve greater comprehension than CD-ROMs, interactive Power Point presentations, and high-quality video productions. These studies used the conventional test score assessment mechanisms. Furthermore, his class room multimedia systems do not track the user. (http://www.superteaching.org/STMIND2.htm)

In summary, there is a need to integrate multiple channels of video, audio, graphics, images and text in a simultaneous synchronized presentation to the user not based on how much they have learned (or how assessments measure their “mastery”) but on how their brain is engaged in the learning process. There is a need to dynamically select the content of these channels to assist the user in tapping into both sides of the brain based on whole-brain learning theories. There is a need for a system that assesses the learner based on how the learner historically interacted with these multimedia channels rather than on questionnaires and traditional testing assessment methods. And as a consequence there is a need for a new kind of learner-centered computer-based training system that supports super-learning techniques.

### BRIEF SUMMARY OF THE INVENTION

The foregoing problems found in the prior art have been successfully overcome by the present invention, which is directed to systems and methods that present to the user a dynamically changing combination of multimedia items such as video, audio, vector graphics, raster images, and text based on the learner's whole-brain super-learning interaction with previously presented material.

In the preferred embodiment, this invention contains a logical unit that determines how the multimedia items are mixed into the multiple channels based on the rules associated with the learner's interaction with previous content presentations. For example, if a multimedia item is known to impact the left part of the brain, and the user did not react quickly, then other multimedia items that can engage that part of the user's brain can randomly appear in the next few minutes to stimulate that part of the brain. All of this can even happen independently of the actual curriculum material to engage both sides of the brain and create an atmosphere conducive to super learning. Thus, based on the path through content nodes that the user has taken in the past, the logical unit determines what parts of the brain the user tends to utilize and modifies the super-learning multimedia combinations accordingly.

A computer system of this invention allows the user to simultaneously observe multiple video, images, and text that stimulate various parts of the brain and engage the user in interactive super-learning. The system selects and integrates multiple channels of media based on how a learner's historical track record relates to a set of learner-centered rules especially those related to whole-brain super-teaching theories.

### BRIEF DESCRIPTION OF THE SEVERAL VIEWS OF THE DRAWING

In order that the manner in which the above recited advantages and objects of the invention are obtained, a more particular description of the invention will be rendered by reference to specific embodiments thereof that are illustrated in the appended drawings. Understanding that these drawings depict only typical embodiments of the invention and are not to be considered to be limiting of its scope, the invention will be described and explained with additional specificity and detail through the use of the accompanying drawings in which:

FIG. 1 is a system architecture diagram illustrating the system for a general content node.

### DETAILED DESCRIPTION OF THE INVENTION

The following invention is described by using a specific example of the system when the user is at a given representative content node. Using the diagram and the specific example in this manner to present the invention should not be construed as limiting of its scope. The present invention contemplates systems that use any logic that allows the multiplicity of content channels to appear on a computer screen based on whole-brain and super-learning theories and the complete historical record of the learner.

Embodiments of the present invention may comprise a general-purpose computer. Such a general-purpose computer may have any number of basic configurations. For example, such a general purpose computer may comprise any or all of a central processing unit, one or more specialized processors, system memory, mass storage such as a magnetic disk, an optical disk, or other storage device, an input means such as a calculator keypad, keyboard and/or mouse, a display device, and printer or other output device. An apparatus implementing the methods of the present invention can also comprise a special purpose computer, calculator or other hardware systems and all should be included within its scope.

Embodiments within the scope of the present invention also include computer readable media having executable instructions. Such computer readable media can be any available media that can be accessed by a general purpose or special purpose computer via the Internet, networks, and attached computer readable media. By way of example, and not limitation, such computer readable media can comprise RAM, ROM, EPROM, CD ROM and other optical disk storage, magnetic storage devices, or any other medium which can be use to store the desired executable instructions. Combinations of the above should also be included within the scope of computer readable media.

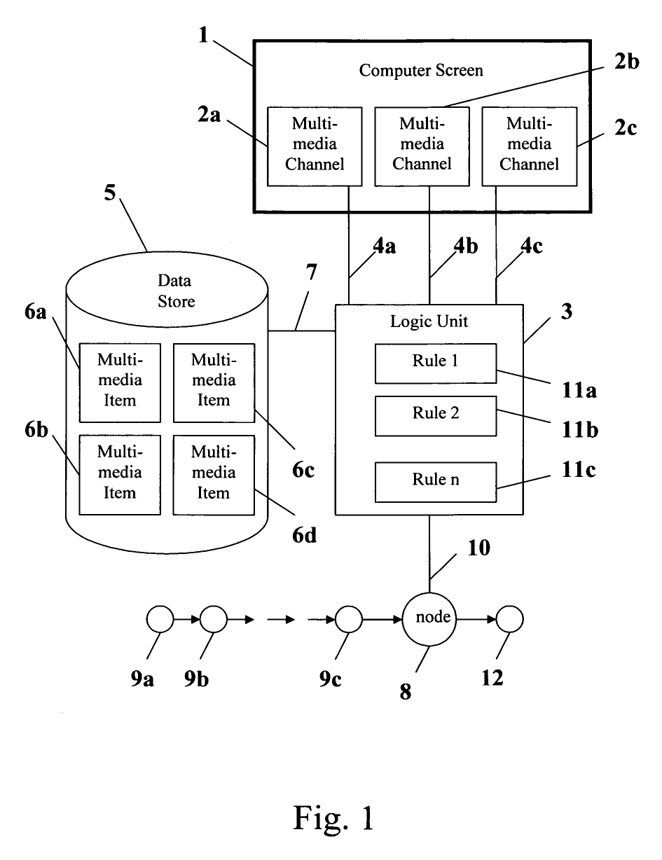

The systems of the present invention comprise computer readable media that enable the characterization of multimedia items including but not limited to video, audio, graphics, images, and text. In the preferred embodiment, computer readable media comprises electronic database tables consisting of collections of records that index the multimedia items. FIG. 1 represents the relationship between this collection of multimedia items and the way in which they are displayed on a computer screen.

More specifically, FIG. 1 illustrates the system architecture as a computer screen 1 with a multiplicity of multimedia channels depicted in FIG. 1 as three areas 2a, 2b, and 2c on the computer screen 1. But in the preferred embodiment of this invention, a channel need not have a visual representation; for example, it could represent an audio segment. The system contains a learner-centered media-integration logical unit 3 that determines how multimedia items will be assigned via the links 4a, 4b, and 4c to the corresponding channels 2a, 2b, and 2c.

The logical unit 3 accesses a data store 5 containing a multiplicity of multimedia items 6a, 6b, and 6c through the link 7. The method used by the logical unit 3 to determine how to combine the multimedia items 6a, 6b, and 6c at a current content node 8 in the preferred embodiment depends on the historical path represented by content nodes 9a, 9b, and 9c previously visited by the user.

FIG. 1 represents the system at a current content node 8 as indicated by link 10. FIG. 1 also can apply to each content node 9a, 9b, and 9c in the historical path as if such node were the current content node 8. So at each historical node encountered by the user, the logical unit 3 selects and integrates multimedia items 6a, 6b, and 6c to display in the multimedia channels 2a, 2b, and 2c for that historical node.

The logical unit contains a multiplicity of rules represented by 11a, 11b, and 11cthat determine the mix of multimedia items 6a, 6b, and 6c. These rules are based on whole-brain and super-learning theories that determine the mixture of multimedia items to display on the screen. For example, there can be rules that check the historical path for particular sequences of nodes. There can he rules that check for the frequency of particular nodes in the historical path. There can be rules that check to see if a specific type of node has been visited. There can be rules that measure the time in or between previously visited nodes. In essence, any logical rule that can be applied to the historical path of nodes can be assigned to a particular mixture of multimedia items to display in the channels displayed on the screen. Each of the rules measures the user's interaction with the channels designed to emphasize either left-brain (rational, sequential, mathematical, words, etc.) or right-brain (intuitive, random, artistic, images, etc.) stimulus as commonly known in learning theory. The logical unit then determines from the historical path the combinations of channel types that increase the correct responses from the user.

The next node 12 that the system moves to depends on the user's interaction with the multimedia items displayed on the computer screen as well as the historical path of nodes in a variety of ways that are well known in the literature.

One application of this invention involves a training company that creates software for employees of companies that desire to significantly impact the learning experience of their employees. This invention allows an e-Learning system to integrate whole-brain super-learning theories into the delivery of corporate content.

We claim:

1. A system comprising a computer screen, a multiplicity of channels, a multiplicity of multimedia items, and a logical unit that selects the multimedia items for each channel and selects and combines the channels on the computer screen through a multiplicity of rules based on the user's past interaction with channels having known left-brain or right-brain dominant multimedia items.

2. The system of claim 1, further comprising a storage unit that the logical unit uses to record the historical path containing each user interaction with the channels of information and provides statistics for the logical unit to use in implementing the rules.

3. The system of claim 2, further comprising a storage unit of left-brain and right-brain characteristics which the logical units assigns to multimedia items in order to build the rules that determine what is displayed next in a given channel based on particular sequences or frequencies of previously displayed multimedia items.

4. A method of selecting multimedia items to display on a computer screen comprising the tracking of the user's interactions with previously displayed multimedia items with known left-brain and right-brain characteristics to increase the frequency of those characteristics that historically the user responds to most accurately.

5. The method of claim 4, further comprising a multiplicity of channels that combines the multimedia items into combinations of left-brain and right-brain characteristics (a whole-brain approach) with the dominant channel paralleling those characteristics that historically the user responds to most accurately.
